(19) United States
(12) Patent Application Publication
(10) Pub. No.: US 2009/0109009 A1
(43) Pub. Date: Apr. 30, 2009

(54) AUDIBLE ALERT ON SCHOOL BUSES FOR BUS STOP ACTIVE MASTER FLASHER SWITCH

(75) Inventor: Matthew J. Gumbel, Fort Wayne, IN (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 11/867,787

(22) Filed: Oct. 5, 2007

(51) Int. Cl. B60Q 1/26

(52) U.S. Cl. 340/433

(57) ABSTRACT

A vehicle lighting control system provides aural warning that the conditions for activating pupil warning lights have been met but that the pupil warning light system has not been armed, preventing operation of the lights.

### BACKGROUND OF THE INVENTION

1. Technical Field

The invention relates to vehicle lighting control and more particularly to a system for alerting a school bus driver to a potentially automated request for activation of passenger boarding warning lights without activation of a master switch.

2. Description of the Problem

School bus drivers may be required by law to activate pupil warning lights (PWL) when children are boarding or disembarking from a bus. On many buses the PWL are activated automatically by opening or closing of the bus door, provided a Master flasher switch has previously been turned on. If the Master flasher switch has not been activated pupils may board or disembark without activation of the PWL even though a request for activation of the PWL has been made by opening of the doors. It would be desirable to further reduce the possibilities for error on the part of a driver.

### SUMMARY OF THE INVENTION

The invention provides a lighting control system providing an audible alarm which is sounded under circumstances which indicate a need to activate the PWL when the PWL system has not been armed. The audible alarm sounds when the driver/operator depresses a PWL flasher ON/OFF switch to commence a bus stop, or, a “Door Open” switch indicates opening of the main entry/egress door without the master flasher switch being turned on. If the driver is opening the door for a reason other than to allow children to embark or disembark he or she can ignore the alarm. If children are present the operator should be alerted to activate the Master flasher switch. The alarm can be dependent upon vehicle speed. If the Flasher ON/OFF switch is pressed while the vehicle is at speed the alarm will not sound even if the master flasher switch is off.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a schematic view of a school bus incorporating the invention.

FIG. 2 is schematic view of an instrument panel for the school bus of FIG. 1.

FIG. 3 is a mixed circuit, block diagram schematic of a electronic control system used to implement the invention.

FIG. 4 is a state diagram illustrating operation of the invention.

### DETAILED DESCRIPTION OF THE INVENTION

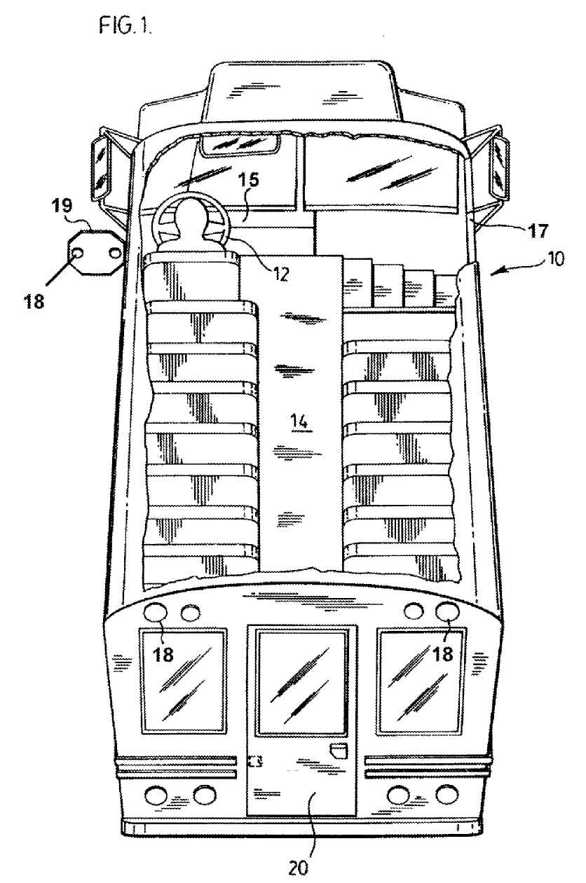

Referring now to the figures and in particular to FIG. 1, a school bus 10 is illustrated with which the present invention is advantageously employed. School bus 10 includes a driver station 12 at the front of a passenger compartment 14. The driver station 12 is provided with controls and indicators necessary for operation of school bus 10, many of which are located on a dash board 15. The school bus 10 is provided with a passenger door for ingress and egress adjacent the driver station 12. An emergency door 20 is conventionally located at the rear of the passenger compartment 14. Pupil warning lights (PWL) 18 are located on the exterior of the school bus 10 including the back of the bus, on a folding sign 19 along the side of the vehicle and at the front of the bus (not shown). PWL 18 are to turned on during boarding and egress of school age children.

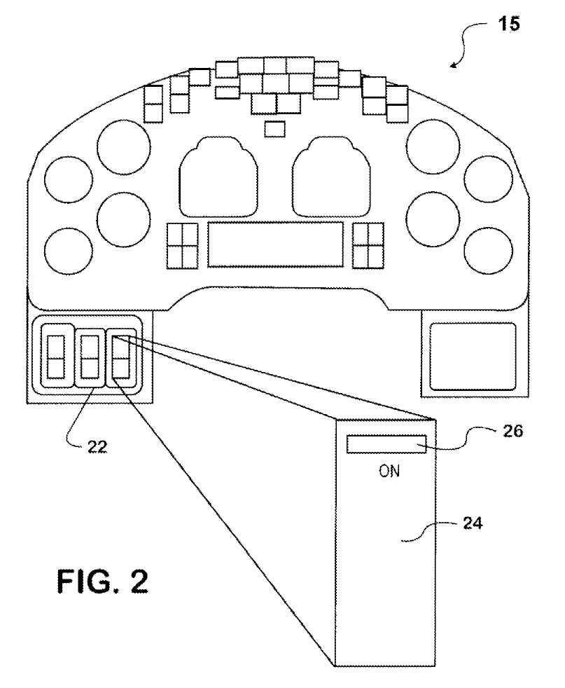

Referring now to FIG. 2, instrument panel 15 is shown in relevant detail. Panel 15 incorporates an auxiliary switch panel 22 which includes a PWL master flasher switch 24 (in effect an arming switch). PWL master flasher switch 24 does not turn PWL 18 on and off, but instead arms them. An ON/OFF indicator lamp 26 may be included in the master flasher switch 24 to indicate whether the PWL 18 are “armed”. Master flasher switches 24 provide a means of deactivating automatic PWL 18 activation. Such a feature is useful on a vehicle where PWL 18 operation is triggered by repositioning of the door 17, or follows as a consequence of some other driver action required to allow passengers to embark and disembark. In some vehicles PWL 18 activation may be effected by another switch in panel 22, or by use steering wheel mounted speed control switches monitored by an appropriately programmed controller.

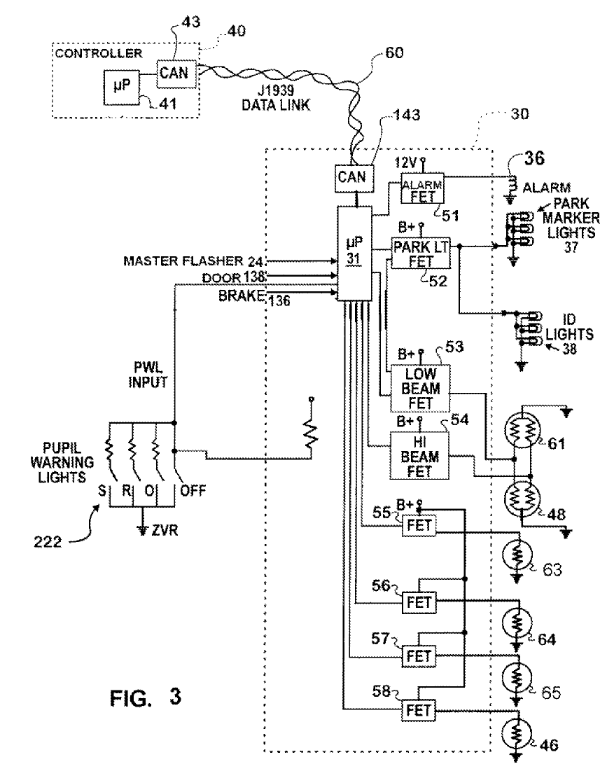

Referring to FIG. 3, PWL 18 operation may be implemented by an electrical system controller 30 such as used with a vehicle controller area network. The following description represents one way of effecting control of the lighting, which may be implemented in a number of ways. Those skilled in the art will immediately realize that particular implementations of the invention will depend upon a particular vehicle's control system. A representative way of implementing vehicle lighting control could be through an electrical system controller 30. In such a system a plurality of lamps 63, 64, 65 and 46 represent a PWL 18 constellation. Lamps 64, 64, 65, and 46 are energized, respectively, by field effect transistor (FET) switches 55, 56, 57 and 58, which are part of the electrical system controller 30. Gate signals for the FET switches 55, 56, 57 and 58 are generated by an ESC microprocessor 31, which executes a program controlling the operation of the PWL 18. As is conventional, the PWL 18 constellation is operated to flash from side to side of a vehicle. Additional FET switches (an Alarm control FET 51, a Park light FET 52, low and high beam control FETs 53, 54) provide for control of an audible alarm 36 (illustrated as an inductance), park marker lights and ID lights 37, 38 and the the low and high beam filaments 61, 48 of the vehicle's headlamps. Additional FETs (not shown) provide control of turn signal indicators, brake lamps, etc. All gating signals are generated by microprocessor 31 in response to switch inputs and programming of the microprocessor 31. Because lighting operation is handled by programming it will be readily recognized that such control may be distributed to another controller such as a cluster controller.

Microprocessor 31 is conventionally programmed as a microcontroller. The programming directs responses to various status indications and switch inputs, whether directly received, decoded from messages broadcast over the controller area network (represented by SAE (Society of Automotive Engineers) J1939 datalink 60), or received over other datalinks, such as a SAE J1708 serial datalink (not shown). An SAE J1708 datalink between ESC 30 and a switch pack (not shown) could readily be used for coupling the status of a master flasher switch 24 as opposed to the illustrated alternative (simply labeling the connection a J1708 datalink is enough to make the description explicit). Because of the availability of status inputs from various sources to microprocessor 31, PWL 18 operation can be closely tied to operating conditions indicated by the inputs. The particular inputs of interest here are an engine running message generated by the engine controller 40, the status of a master flasher switch 24 determined by the ESC 30, a door open switch 138, a park brake position switch 136 and steering wheel switches 222 (which are adapted speed control switches used in some school bus application for activation of the PWL 18. A generic controller 40 is illustrated connected to ESC 30 by CAN interfaces 43, 143 and an SAE J1939 datalink 60. Controller 40 may be an engine controller reporting that the vehicle is on, or a transmission controller reporting vehicle speed. Controller 40 is illustrated as including its own autonomous microprocessor 41.

PWL 18 operation is illustrated as disabled in response to lack of activation of the master flasher switch 24 and conversely enabled in response to depression of the master flasher switch 24, that is, its default state on starting the vehicle is off. Alternatively, the default status could be that PWL 18 operation is enabled on start. PWL 18 operation is not initiated in response to “arming” the system, but depends upon one or more additional states being met. These may include, depending upon how the vehicle is configured by the customer, automatic operation upon opening of the door 17 or automatic operation upon opening the door and setting of a park brake 136. These may be generally referred to as indirect control for the pupil warning light trigger switch. Additionally there may be a requirement that vehicle speed be less than Vmin (reported over J1939 datalink 60 from controller 40) before the pupil warning lights 18 can be operated. The present invention provides for activating aural alarm 36 in response to an attempt to activate, or the occurrence of conditions which activate PWL 18, operation absent the system having been armed. That is to say, with master flasher switch 24 set to OFF. This alerts the operator who can respond by setting the master flasher 24 to on, deactivating the PWL 18 request (where it is manual) or by ignoring the alarm should passenger operations not be in progress.

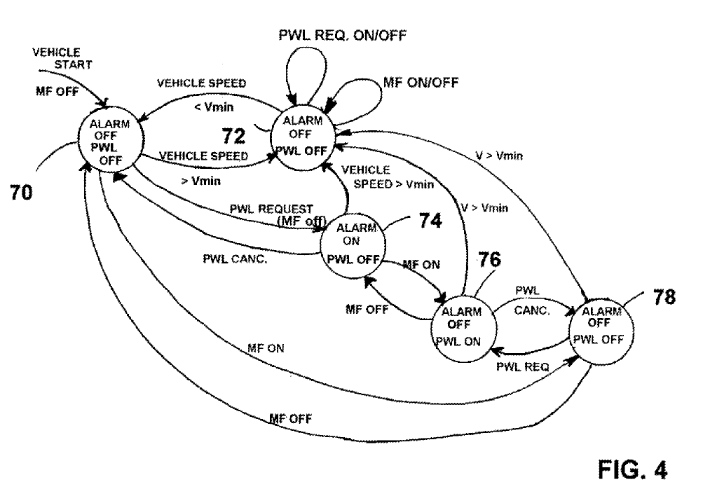

Referring now to FIG. 4, a possible state diagram illustrates operation of the programming for electrical system controller 30 in so far as it relates to activating PWL 18 operation. The possible primary conditions for directly triggering PWL 18 operation have been conflated as a “PWL request”, whether the condition is manually generated or occurs automatically with another operation. For example, a PWL 18 request can be an open door condition, activation of switch 222, etc. On vehicle start (reported over the SAE J1939 datalink 60) the master flasher switch 24 assumes a default OFF condition and the system starts at state 70 with the aural alarm 36 off and PWL 18 not in operation. Vehicle speed is assumed initially to be zero (i.e. below Vmin) since the vehicle has just been started. Vehicle speed above a minimum threshold operates to disable PWL 18 operation. Accordingly, detection of a condition that vehicle speed exceeds the minimum Vmin results in the system moving to state 72 with the alarm off and PWL 18 operation off. A change in the PWL 18 operation request status in state 72 does not result in a change of state, preventing extraneous activation of the alarm 36. Similarly a change in the master flasher switch 24 status does not produce a transition from the state. However, in both the case of a request for PWL or a change in the master flasher status the respective request or change is retained in memory. This could be reflected in an enhanced state diagram as a change in status, but it would have no effect on alarm or PWL operational status. Should vehicle speed fall below Vmin the system state returns (or changes) to state 70.

Additional transitions are possible from default state 70. Upon occurrence of a request for PWL 18 operation (or should the system attempt to return to state 70 from state 72 with a pending PWL request) the system state moves to state 74 where alarm 36 is active and PWL 18 operation is off. From state 74 three things can happen, the PWL request can be removed (followed by return to state 70), the master flasher switch can be turned on (state changes to state 76), or another condition, such as an increase in vehicle speed can occur, which results in disabling the alarm 36 (change in state to state 72). Vehicle speed below Vmin is not treated as a request for activation of the PWL 18. State 74 cannot be reached directly from the default state 70.

State 76 corresponds to the conditions for PWL 18 operation having been met including the system having been armed by setting of the master flasher switch 24 to on, a request for PWL 18 operation being present and vehicle speed being below Vmin. In state 76 the aural alarm 36 is off and PWL 18 operation is active. As already stated, state 76 can be reached from state 74 by activating the master flasher switch 24. Should the master flasher switch 24 be turned off while PWL 18 operation is occurring then the system state returns to state 74, and an aural alarm 36 is sounded. Should vehicle speed exceed Vmin the state transition is to state 72 with the alarm 36 off and PWL 18 operation cancelled. It would of course be possible to add an additional state allowing the master flasher switch 24 to be turned off to discontinue PWL 18 operation once initiated without sounding of an alarm based on an assumption that the step had been taken deliberately, however, the preferred embodiment does not provide for this possibility.

From default state 70 activation of the master flasher switch 24 results in a transition to state 78. In state 78 the alarm 36 and the PWL 18 remain off. A return transition path exists from state 78 to default state 70 conditioned on the master flasher switch 24 being moved to off. From state 78 an increase in vehicle speed results in a state transition to state 72. A request for PWL operation produces a transition to state 76 with alarm 36 off and PWL 18 operation on. Should the PWL 18 request be cancelled from within state 76 a state transition from state 76 to state 78 is provided and PWL operation is cancelled.

Some embodiments of the invention may not provide for treatment of vehicle speed. The state diagram of FIG. 4 is fully functional without state 72 and its associated transitions.

The invention particularly provides for reducing the possibility of operator omission of activating an automatic PWL system by failing to turn on a master arming switch.

While the invention is shown in only two of its forms, it is not thus limited but is susceptible to various changes and modifications without departing from the spirit and scope of the invention.

What is claimed is:

1. A vehicle lighting system comprising:
a plurality of exterior lamps on a vehicle including pupil warning lights;
a system controller coupled to receive vehicle status inputs and further coupled to the exterior lamps for controlling the illumination of the pupil warning lights in response to the vehicle status inputs;
the vehicle status inputs including a state for an arming switch for enabling operation of the pupil warning lights and a state for at least one distinct pupil warning light operational trigger; and
an aural alarm coupled to be triggered by the system controller in response to the vehicle status inputs assuming a status with the distinct pupil warning light trigger being active and the arming switch being inactive.

2. A vehicle lighting system as claimed in claim 1, further comprising:
the system controller being coupled to receive vehicle speed measurements and in response to vehicle speed exceeding a predetermined threshold disabling operation of the pupil warning lights.

3. A vehicle lighting system as claimed in claim 2, further comprising:
the system controller assuming a default state upon vehicle start with the arming switch off.

4. A vehicle lighting system as claimed in claim 1, further comprising:
the system controller assuming a default state upon vehicle start with the arming switch off.

5. A vehicle lighting system as claimed in claim 3, wherein the pupil warning light trigger is a switch actuated by opening and closing of a vehicle door.

6. A vehicle lighting system as claimed in claim 4, wherein the pupil warning light trigger is a switch actuated by opening and closing of a vehicle door.

7. A motor vehicle comprising:
exterior lighting including pupil warning lights;
a lighting control system connected to the pupil warning lights to control the illumination thereof:
the lighting control system including switching for the pupil warning lights;
a pupil warning light arming switch connected to the lighting control system;
a pupil warning light trigger switch connected to the lighting control system operable in response to an indirect control input; and
an aural alarm activated in response to the pupil warning light trigger switch indicating a request for operation of the pupil warning lights and the arming switch being set to prevent pupil warning light operation.

8. A vehicle according to claim 7, further comprising:
means for generating a vehicle speed signal;
the lighting control system being coupled to receive the vehicle speed signal and responsive to vehicle speed exceeding a predetermined threshold for disabling operation of the pupil warning lights.
